(19) United States
(12) Patent Application Publication
(10) Pub. No.: US 2005/0046712 A1
(43) Pub. Date: Mar. 3, 2005

(54) Imaging apparatus

(76) Inventor: Kiyotaka Nakabayashi, Saitama (JP)

Correspondence Address: FROMMER LAWRENCE & HAUG LLP, 745 FIFTH AVENUE, NEW YORK, NY, 10151, US

(21) Appl. No.: 10/896,199

(22) Filed: Jul. 20, 2004

(30) Foreign Application Priority Data
Jul. 22, 2003 (JP) 2003-277837

(51) Int. Cl. H04N 5/217

(52) U.S. Cl. 348/241

(57) ABSTRACT

An imaging apparatus which is supplied with an imaging signal taken by an imaging device, and outputs a video signal obtained by applying a predetermined image processing to said imaging signal is disclosed, wherein; when the most-dark point of the imaging signal is shifted from an achromatic axis, a black balance control is carried out so that the most-dark point is corrected in the achromatic axis direction based on the black adaptation rate in consideration of an adaptation effect of human eye to black.

### CROSS REFERENCE TO RELATED APPLICATION

This application claims priority from Japanese Priority Document No. 2003-277837, filed on Jul. 22, 2003 with the Japanese Patent Office, which document is hereby incorporated by reference.

### BACKGROUND OF THE INVENTION

1. Field of the Invention

The present invention relates to an imaging apparatus, and particularly to an imaging apparatus where a black balance control is carried out so as to be viewed with the same level to black by considering the adaptation effect of human eye even when the most-dark portion in the image is shifted from an achromatic axis.

2. Description of the Related Art

In a conventional technology, a black adaptation correction is applied to the most-dark point which is capable of being outputted to a media (such as image display apparatus, and a recording media such as printing paper and the like) as disclosed in a Patent Document: 1 as mentioned later. Further, a conventional clamp control circuit generally comprises, as shown in FIG. 7, a lens system 11 for focusing an imaging light from an object, a CCD 12 for converting the imaging light focused by the lens system 11 into an electric signal, a S/H & AGC 13 for sampling and gain-controlling the electric signal converted by the CCD 12, an A/D converter 14 for converting thus sampled and gain-controlled electrical signal by the S/H & AGC 13 into a digital signal, a clamp circuit 15 for carrying out a black balance correction of the digital signal, a white balance circuit 16 for carrying out a white balance correction, a gamma correction circuit 17 for obtaining color difference signals, a signal processing circuit 18 for generating a video signal, and a specified color extracting circuit 19 for detecting the most-dark point from the imaging signal.

The operation of the imaging apparatus thus configured as above is described hereinafter with reference to a flowchart in FIG. 8.

At first, a calculation for clamps is executed by subtracting a signal level corresponding to OPB (a signal level of black when light is physically shielded from an imaging device; the most-dark point enabled to be outputted) without using image information of an object at step ST21. Then, a control of a clamp circuit is carried out with the calculated result at step ST 22.

This control method is disclosed also in a Japanese Laid-Open Patent 2002-118858 as another conventional technology. In this conventional technology, an optical black area is provided on the imaging device in order to obtain an imaging signal for a black level adjustment from outside of an effective imaging area of the imaging device such as a CCD, and a black balance is carried out based on the imaging signal obtained from this optical black area.
Patent Document 1: Japanese Laid-Open Patent 2000-175062
Patent Document 2: Japanese Laid-Open Patent 2002-118858

However, in the imaging apparatus as described as a conventional technology, for example, in a case where an object is taken by a camera, when a dynamic range of the image signal obtained thereby does not fully use the most-dark point which is available from the camera, namely, a dynamic range of the camera is not fully used, the object used to be picked-up the most-dark point becomes a floating black one depending on the image taking condition even in a case where there is a black portion in the object. Further, in this case, there is a problem that noises are visible at dark portions of the image. Accordingly, taking into consideration of above mentioned matters, it becomes necessary to propose an imaging apparatus having a clamp control circuit by the black balance correction in consideration of an adaptation effect of human eye to black.

### SUMMARY OF THE INVENTION

In order to solve the above problem, an imaging apparatus of the present invention is configured to have following construction.

(1) The imaging apparatus is such an imaging apparatus that is supplied with an imaging signal taken by an imaging device, applies a predetermined image processing to the imaging signal, and outputs a video signal. When the most-dark point of the imaging signal is shifted from an achromatic axis, a black balance control is carried out so that the most-dark point is corrected in the achromatic axis direction based on a black adaptation rate in consideration of an adaptation effect of human eye to black.

(2) The imaging device comprises a clamp circuit supplied with an imaging signal taken by an imaging device for clamping a black level of the imaging signal, a most-dark point detecting circuit for detecting the most-dark point of the imaging signal, a white balance circuit supplied with the imaging signal the black level of which is clamped at the clamp circuit for carrying out the white balance correction of the imaging signal, and a signal processing circuit supplied with the imaging signal which is white balance corrected at the white balance circuit for generating a video signal, wherein the most-dark point detecting circuit detects the most-dark point of the imaging signal, carries out a black balance correction so that the most-dark point thus detected is corrected in the achromatic axis based on the black adaptation rate, and controls the clamp circuit.

(3) The imaging apparatus as cited in (2), wherein the imaging device is a solid state imaging device such as CCD and the like, and is provided with respect to each primary colors R, G, and B.

(4) The imaging apparatus as cited in (2), wherein the black adaptation rate of the clamp circuit is inputted through a GUI.

According to the present invention, even when the most-dark point in the image is shifted from an achromatic axis, it is able to carry out a black balance control by considering an adaptation effect of human eye to black so as to be seen with the same level. Further, the present invention at least includes a semi-conductor imaging device, a detecting circuit for three primary color signals, the most-dark point detecting circuit, a clamp control circuit, and a white balance control circuit; is able to carry out a black balance correction based on a black adaptation by detecting the most-dark point of the taking image; and is able to control the clamp circuit. Further, in this clamp control circuit, it is possible to input an adaptation rate to black through a GUI (Graphic User Interface), and is possible to enlarge the dynamic range of the imaging apparatus by the black balance control. Further, it is able to reduce noises at the most-dark point by the black balance control.

### BRIEF DESCRIPTION OF THE DRAWINGS

FIG. 1 is a block diagram constituting an imaging apparatus according to the present invention;

FIG. 2 is a flowchart showing an operation of an imaging apparatus according to the present invention;

FIG. 3 is a drawing for explaining a case of detecting the most-dark point according to the present invention;

FIG. 4 is a schematic drawing for explaining a black balance correction according to the present invention;

FIG. 5 is a display image for inputting an adaptation rate to black according to the present invention;

FIG. 6 is a specific example of a function Υr according to the present invention;

FIG. 7 is a block diagram of an imaging apparatus according to the prior art; and

FIG. 8 is a flowchart showing an operation of an imaging apparatus of the prior art.

### DESCRIPTION OF THE PREFERRED EMBODIMENT

Hereinafter, an imaging apparatus which is one example of the present invention is described with reference to the drawings.

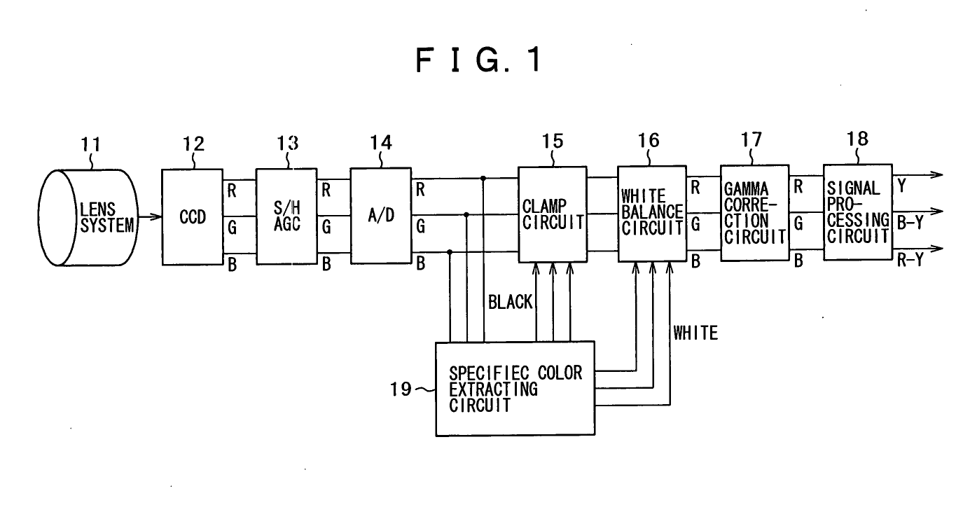

The imaging apparatus of the present invention basically comprises, as shown in FIG. 1, a lens system 11 for focusing an imaging light from an object, a CCD (Charge Coupled Device) 12 for converting the imaging light from the lens system 11 into an electric signal by optical-electrical conversion, a S/H & AGC 13 for sampling/holding and gain-controlling the converted electric signal, a clamp circuit 15 for carrying out a black balance correction, a white balance correction circuit 16 for carrying out a white balance correction, a gamma correction circuit 17 for generating color difference signals, a signal processing circuit 18 for generating a video signal, and a specified color extracting circuit 19.

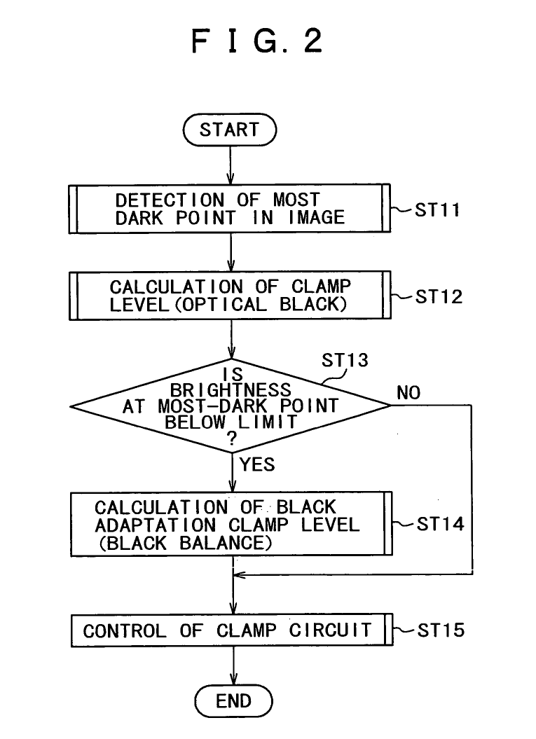

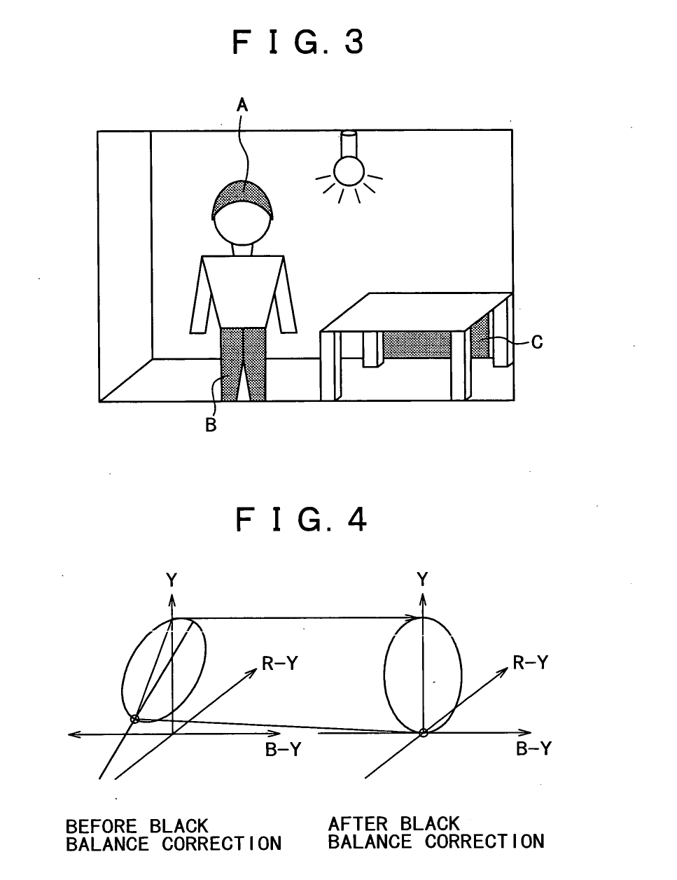

The operation of the imaging apparatus configured as described above is now described. At first, an imaging light enters on the CCD 12 as a semiconductor imaging device through a lens system 11 for focusing the imaging light. Thus entered incident light on the CCD 12 is converted into an electric signal by photo-electric conversion. Thus obtained electric signal is inputted to the S/H & AGC 13, and the sampled and gain-controlled signal from the S/H & AGC 13 is inputted to an A/D converter 14. The signal inputted to the A/D converter 14 is converted into digital signal, and is carried out a black balance correction by the clamp circuit 15. The black balance correction is a signal processing for correcting a happening that a black of the imaging signal becomes floating depending on the image taking condition and the most-dark point is unwillingly shifted from an achromatic axis. In an object as shown in FIG. 3, for example, the most-dark point such as a black hair (point A), a black portion (point B) in clothes, and a dark portion (C) where the light is not incident is detected. Further as shown in FIG. 4, the detected most-dark point is subjected to correct in the original point (Y, B-Y, R-Y)=(0, 0, 0) direction, namely in the achromatic axis direction in consideration of the black adaptation rate which is the adaptation rate of the adaptation effect of human eye to black. The clamp control in the case where the black balance correction is carried out and the clamp circuit is controlled, is shown in FIG. 2. Namely, when brightness at most-dark point is below limit, a black adaptation clamp level is calculated so that control of the clamp circuit is performed. Otherwise, when the brightness at most-dark point is over the limit, the control of the clamp circuit is simply performed.

Now, specific signal processing will be described hereinafter. Firstly, RGB signals after the A/D converter 14 are converted into XYZ values which are values considered the visual characteristic of human eye. That is, RGB values of 8 bits are converted as shown in Formula (1) into RGB values which are carried out by exponential correction using the sRGB conversion which is an International Standard of a color space defined by IEC (International Electrotechnical Commission). Other colors, G and B are also converted with similar Formula.

$$\begin{matrix}{R}_{sRGB}^{′} = {R}_{δ bit} / 255.0 \\ if {R}_{sRGB}^{′} < 0.04045 \\ then \\ R = {R}_{sRGB}^{′} / 12.92 \\ else \\ R = {( ( {R}_{sRGB}^{′} + 0.055 ) / 1.055 )}^{2.4}\end{matrix} \qquad ( 1 )$$

Then, as shown in Formula (2), the RGB values converted non-linearly are converted to the XYZ values.

$$( \begin{matrix}X \\ Y \\ Z\end{matrix} ) = A ( \begin{matrix}R \\ G \\ B\end{matrix} ) \qquad ( 2 )$$

In this case, for example, values as shown in Formula (3) are used as this matrix for the sRGB conversion.

$$A = ( \begin{matrix}0.4124 & 0.3576 & 0.1805 \\ 0.2126 & 0.7152 & 0.0722 \\ 0.0193 & 0.1192 & 0.9505\end{matrix} ) \qquad ( 3 )$$

Such conversion from these RGB values to the XYZ values may be performed by using a lookup table.

Then, the black is defined as shown in Formula (4) in consideration of the black adaptation wherein the black adaptation rate is defined as Kadp. In thus case, X_{S.IN.MK}, Y_{S.IN.MK}, Z_{S.IN.MK} are the XYZ values at the detected most-dark point. Further, the XYZ values of the most-dark point considering the black adaptation rate are defined as X_{S.IN.K}, Y_{S.IN.K}, Z_{S.IN.K}. In thus case, if the Kadp=1.0, this represents the black adaptation rate of 100%, and the black balance correction is carried out by assuming that it is fully black-adapted to the detected most-dark point of the object. Further, if the Kadp=0.0, this represents the black adaptation rate of 0%, and the black balance correction is not carried out in this case by assuming that it is not adapted to black. This black adaptation rate represents an adaptation rate of a human eye to black, and as a result of the experiment disclosed in [K. Nakabayashi, M. D. Fairchild “Appearance match between hardcopy and softcopy using lightness rescaling with black point adaptation,” SPIE/IS & T Electronic Imaging 2002: Proc. SPIE Vol. 4633, page 217 to page 228], optimum value is given to 0.4 to 0.6 which are about a center value, though depending on the object.

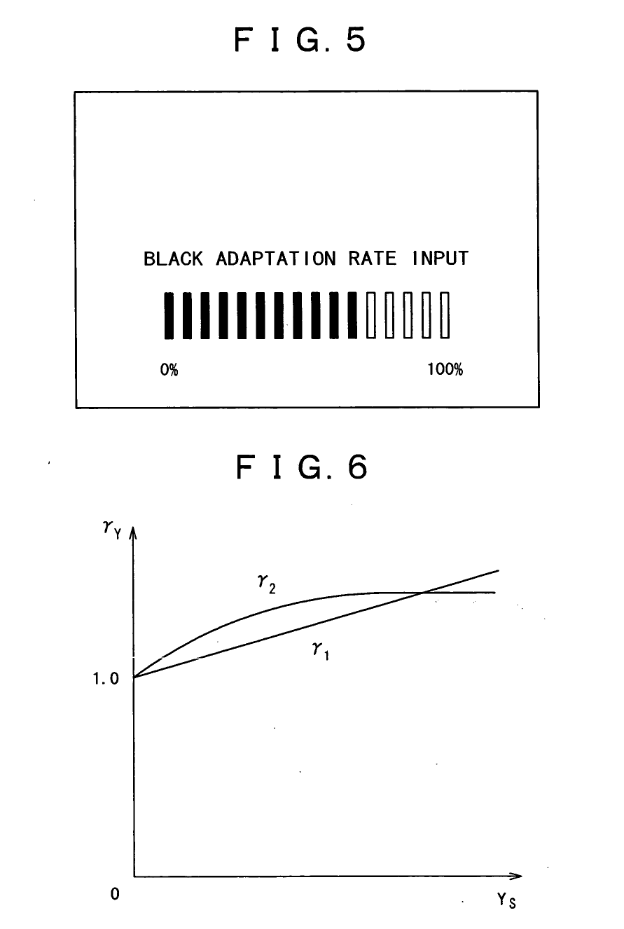

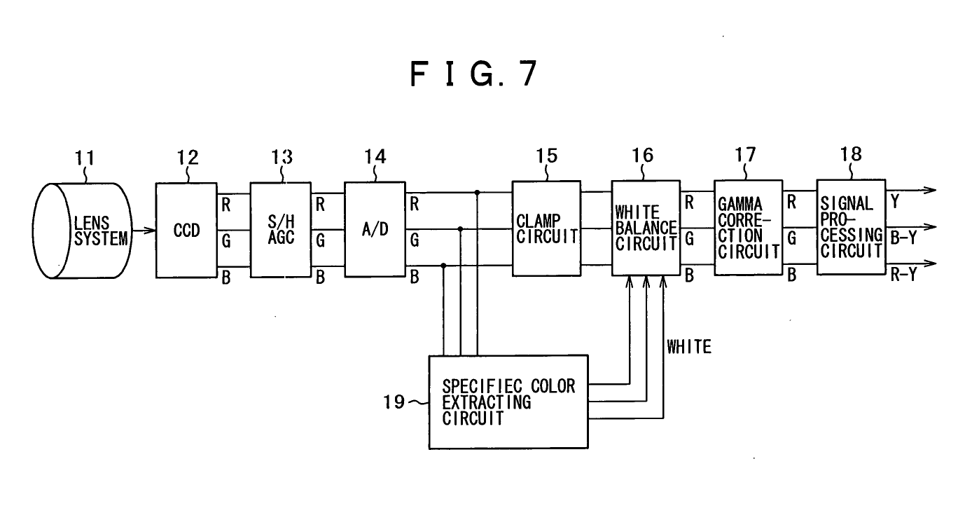

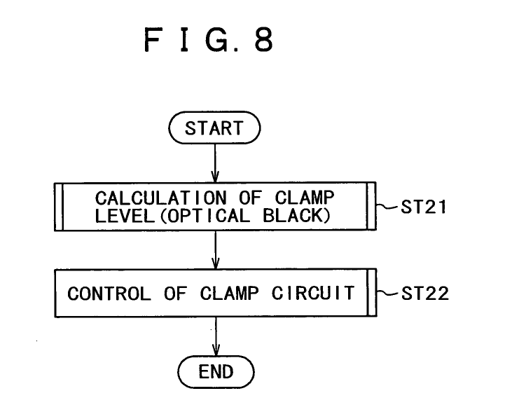

In this case, in the Kadp, the black adaptation rate may be freely inputted, as shown in FIG. 5, by a user using the GUI. The one-third power is used for calculating color perception space of human eyes with a simulated space, but not limited to this.

$$\begin{matrix}{{X}_{S . IN . K}}^{1 / 3} = {K}_{adp} \cdot {{X}_{S . IN . MK}}^{1 / 3} \\ {{Y}_{S . IN . K}}^{1 / 3} = {K}_{adp} \cdot {{Y}_{S . IN . MK}}^{1 / 3} \\ {{Z}_{S . IN . K}}^{1 / 3} = {K}_{adp} \cdot {{Z}_{S . IN . MK}}^{1 / 3}\end{matrix} \qquad ( 4 )$$

Then, a black balance correction conversion as shown by Formula (5) is carried out based on the most-dark point in consideration of the black adaptation defined by the Formula (4). In this case, the X_{S.IN}, Y_{S.IN}, Z_{S.IN} represent the XYZ values of the image data before the black balance correction, and the X_{S.OUT}, Y_{S.OUT}, Z_{S.OUT} are the XYZ values of the image data after the black balance correction.

$$\begin{matrix}{( {X}_{s . out} )}^{1 / 3} = {[ \frac{{( {X}_{S . IN} )}^{1 / 3} - {( {X}_{S . IN . K} )}^{1 / 3}}{1 - {( {X}_{S . IN . K} )}^{1 / 3}} ]}^{{γ}_{X}} \\ {( {Y}_{s . out} )}^{1 / 3} = {[ \frac{{( {Y}_{S . IN} )}^{1 / 3} - {( {Y}_{S . IN . K} )}^{1 / 3}}{1 - {( {Y}_{S . IN . K} )}^{1 / 3}} ]}^{{γ}_{Y}} \\ {( {Z}_{s . out} )}^{1 / 3} = {[ \frac{{( {Z}_{S . IN} )}^{1 / 3} - {( {Z}_{S . IN . K} )}^{1 / 3}}{1 - {( {Z}_{S . IN . K} )}^{1 / 3}} ]}^{{γ}_{Z}}\end{matrix} \qquad ( 5 )$$

In this case, γx, γy, and γz are defined by Formula such as Formula (6), and are defined by a monotone increasing function as shown in FIG. 6, for example.

$$\begin{matrix}{γ}_{X} = f ( {X}_{S . IN . K} ) \\ {γ}_{Y} = f ( {Y}_{S . IN . K} ) \\ {γ}_{Z} = f ( {Z}_{S . IN . K} )\end{matrix} \qquad ( 6 )$$

Thus obtained X_{S.OUT}, Y_{S.OUT}, Z_{S.OUT} after the black adaptation are to be returned to the RGB values by carrying out reverse-conversion based on the Formula (1), the Formula (2), and the Formula (3).

Then, the signal after the black balance correction is inputted to a white balance correction means and a white balance circuit 16. Further in this white balance circuit 16, R, G, B signals are detected, for example, and the detected values are inputted to the CPU. This CPU determines a color temperature of a currently taking object, for example, from thus inputted R, G, B signals and sets the control values of the white balance correction means suitable for the color temperature.

As described above, it is able to carry out black balance correction where the adaptation of human eye to black is considered, and after the correction, the most-dark point in the image is corrected in the achromatic axis direction of the original point (Y, B-Y, R-Y)=(0, 0, 0), as shown in FIG. 4, so that resultantly the dynamic range is expanded, and the noises at the black level are reduced.

Even the most-dark point in the image is shifted from the achromatic axis, it is able to carry out a black balance control in order to be seen with the same level by considering the adaptation effect of human eye to black.

1. An imaging apparatus which is supplied with an imaging signal taken by an imaging device, and outputs a video signal obtained by applying a predetermined image processing to said imaging signal; wherein;
when the most-dark point of the imaging signal is shifted from an achromatic axis, a black balance control is carried out so that the most-dark point is corrected in the achromatic axis direction based on a black adaptation rate in consideration of an adaptation effect of human eye to black.

2. An imaging apparatus which includes a clamp circuit supplied with an imaging signal taken by an imaging device for clamping a black level of the imaging signal, a most-dark point detecting circuit for detecting the most-dark point of the imaging signal, a white balance circuit supplied with the imaging signal the black level of which is clamped at the clamp circuit for carrying out the white balance correction of the imaging signal, and a signal processing circuit supplied with the imaging signal which is white balance corrected at the white balance circuit for generating a video signal, wherein;
a most-dark point detecting circuit detects the most-dark point of the imaging signal, carries out a black balance correction so that thus detected most-dark point is corrected in the achromatic axis based on the black adaptation rate, and controls the clamp circuit.

3. The imaging apparatus as cited in claim 2, wherein;
the imaging device is a solid state imaging device such as CCD and the like, and is provided with respect to respective primary colors R, G, and B.

4. The imaging apparatus as cited in claim 2, wherein;
the black adaptation rate of the clamp circuit is inputted through a GUI.

5. An imaging method comprising:
a clamping step for clamping a black level of an imaging signal taken by an imaging device;
a detecting step for detecting the most-dark point of said imaging signal;
a white balance correction step for correcting the imaging signal the black level of which is clamped at said clamping step; and
a video signal generating step for generating a video signal from the imaging signal corrected at said white balance correction step, wherein;
said most-dark point detecting step detects the most-dark point of said imaging signal, carries the detected value of the most-dark point by multiplying a black adaptation rate, and controls clamping in said clamping step.

6. The imaging method as cited in claim 5, wherein;
the black adaptation rate is inputted through a GUI.
